(19) United States
(12) Patent Application Publication
(10) Pub. No.: US 2013/0033904 A1
(43) Pub. Date: Feb. 7, 2013

(54) PHASE-SHIFTED FULL BRIDGE CONVERTER WITH REDUCED CIRCULATING CURRENT

(71) Applicant: Zhong YE, Plano, TX (US)

(72) Inventor: Zhong YE, Plano, TX (US)

(21) Appl. No.: 13/566,439

(22) Filed: Aug. 3, 2012

Related U.S. Application Data
(60) Provisional application No. 61/515,210, filed on Aug. 4, 2011.

(51) Int. Cl. H02M 3/335

(52) U.S. Cl. 363/17

(57) ABSTRACT

A phase-shifted full bridge converter is provided. The converter includes a transformer having a primary winding and a secondary winding having a center tap, an input stage comprising a full bridge switching circuit coupled to the primary winding, and an output stage coupled to the secondary winding. The output stage includes a circulating current control circuit to provide a portion of output current to reduce output current provided from the secondary winding during a freewheeling time period and reduce the circulating current in the primary winding.

### CROSS-REFERENCE TO RELATED APPLICATION

This application claims the benefit of priority to U.S. Provisional Patent Application No. 61/515,210, filed on Aug. 4^{th}, 2011, and entitled “A METHOD TO CONTROL PHASE-SHIFTED FULL BRIDGE CIRCULATING CURRENT,” the entirety of which is incorporated herein by reference.

### TECHNICAL FIELD

The present invention relates generally to power conversion, and specifically to a phase-shifted full bridge converter with reduced circulating current.

### BACKGROUND

In the field of power conversion, it is a common practice to convert electrical energy from one DC voltage level to other isolated levels by using high frequency switching technology. The application of switching technology dramatically decreases the size of power converters and improves power conversion efficiency. While enjoying the benefits of switching technology, industry is facing new challenges of the further demands of higher power conversion efficiency and smaller sizes of converters, and lower Electromagnetic Inference (EMI) emission, which is caused by switched currents and voltages.

One popular DC/DC topology is the phase-shifted full bridge DC/DC converter employed especially for high power applications. Such a circuit is described in detail in a Texas Instruments' application note U-136A, entitled “Phase Shifted Zero Voltage Transition Design Consideration and the UC3875 PWM Controller”, published in May 1997. The phase-shifted full bridge DC/DC converter relies on the primary current including power transformer's magnetizing current and the current reflected from the secondary to charge or discharge the parasitic capacitive elements of switching devices of the bridge's lagging leg, and the circulating current and its corresponding energy stored in the transformer leakage inductance to energize a resonance between the capacitive elements of the leading leg's switching devices and the leakage inductance. When the secondary output current reaches a certain level, the switching devices' parasitic capacitance can be fully charged or discharged during the dead time of gate signals allowing for zero voltage switching (ZVS).

A load-dependent circulating current is one of the major drawbacks of the existing ZVS full bridge DC/DC converters. The circulating current passes through most of the power train of the full bridge DC/DC converter, including two bridge switches, a resonance inductor, if any, power transformer primary and secondary windings and output rectifiers, when both top or bottom switches are turned on. During this period, no energy is transferred from the primary side to the secondary side. Certain level circulating current is necessary to achieve ZVS. However, a circulating current above this level will not provide any additional benefits more than the ZVS, but will cause more conduction losses, especially at heavy loads.

### SUMMARY

In accordance with an aspect of the present invention, a phase-shifted full bridge converter is provided. The converter comprises a transformer having a primary winding and a secondary winding having a center tap, an input stage comprising a full bridge switching circuit coupled to the primary winding, and an output stage coupled to the secondary winding. The output stage comprises a circulating current control circuit to provide a portion of output current to reduce output current provided from the secondary winding during a freewheeling time period and reduce the circulating current in the primary winding.

In accordance with another aspect of the invention a DC/DC converter is provided that comprises a transformer having a primary winding and a secondary winding having a center tap, and an input stage comprising a full bridge switching circuit having a first and a second transistor pairs coupled to one another through the primary winding. The DC/DC converter further comprises a controller that controls the switching of the first and second transistor pairs via gate control signals, wherein the controller alternately switches between a first diagonal transistor pair and a second diagonal transistor pair of the first and second transistor pairs to deliver power to the output stage during power delivery time periods. The DC/DC converter further comprises an output stage coupled to the secondary winding. The output stage comprises a first output rectifier having an anode coupled to a first end of the secondary winding and a cathode coupled to a common node, a second output rectifier having an anode coupled to a second end of the secondary winding and a cathode coupled to the common node, an output inductor having a first end coupled to the common node and a second end that is coupled to an output capacitor, which is also coupled between an output terminal and the center tap. The output stage also comprises a circulating current control circuit coupled to the common node to provide a portion of output current to the output inductor to reduce output current provided by the secondary winding during an initial time of a freewheeling time period and reduce the circulating current in the primary winding.

In accordance with yet another aspect of the invention, a method is provided for reducing circulating current in phase-shifted full bridge converter having an input stage coupled to an output stage by a transformer. The method comprises turning on a first diagonal pair of transistor switches of the input stage, temporarily providing a portion of output current to reduce output current provided by a secondary winding of the transformer resulting in the reduction of circulating current in a primary winding of the transformer, and turning off one of the first diagonal pair of transistor switches. The method further comprises turning on one of a second diagonal pair of transistor switches, turning off the other of the first diagonal pair of transistor switches, and turning on the other of the second diagonal pair of transistor switches.

### BRIEF DESCRIPTION OF THE DRAWINGS

FIG. 1 illustrates an example of a phase-shifted full bridge DC/DC converter in accordance with an aspect of the present invention.

FIG. 2 illustrates waveform timing diagrams of input switching signals and primary winding signals of a conventional phase-shifted full bridge DC/DC converter.

FIG. 3 illustrates waveform timing diagrams of input switching signals, primary winding signals and a circulating current control signal of a phase-shifted full bridge DC/DC converter in accordance with an aspect of the present invention.

FIGS. 4-7 illustrate current flow schematic diagrams at different states during operation of the phase-shifted full bridge DC/DC converter in accordance with various aspects of the present invention.

FIG. 8 illustrates an example of a method for reducing circulating current in a phase-shifted full bridge DC/DC converter in accordance with an aspect of the present invention.

### DETAILED DESCRIPTION

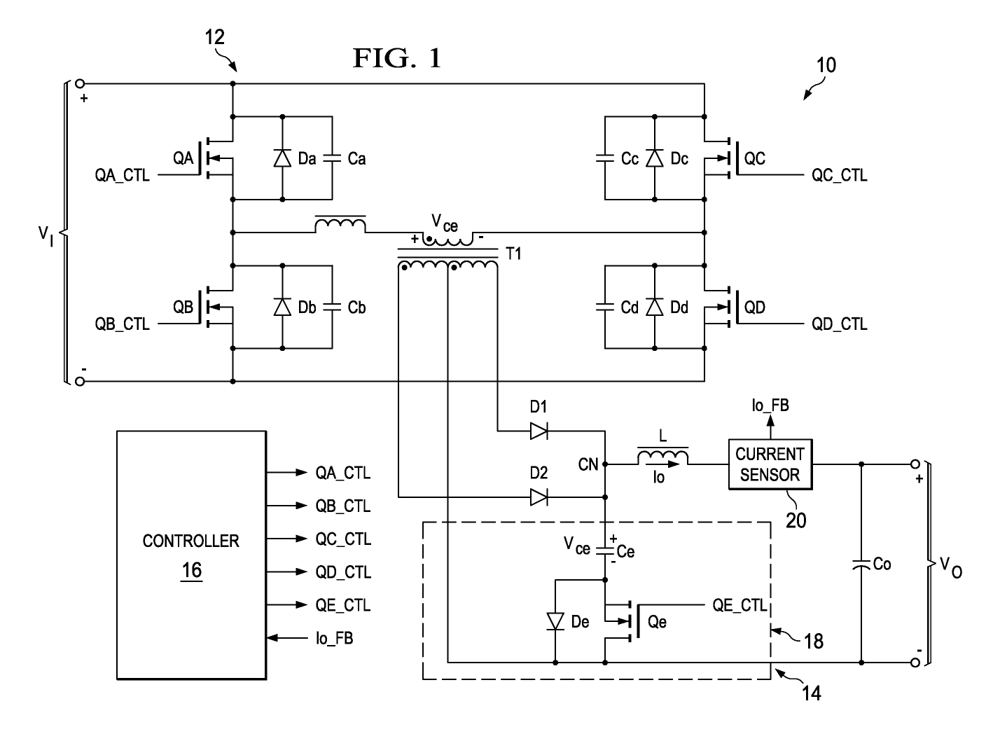

FIG. 1 illustrates an example of a phase-shifted full bridge DC/DC converter 10 in accordance with an aspect of the present invention. The phase-shifted full bridge DC/DC converter 10 includes an input stage 12, an output stage 14 and a controller 16. The input stage 12 is a full bridge switching circuit having four switching devices shown as n-channel power MOSFETs QA, QB, QC, and QD. The power MOSFETs each have an intrinsic body diodes labeled Da, Db, Dc and Dd, respectively, connected from source to drain, with the anode of the body diode connected to the source of the MOSFET and a parasitic junction capacitance labeled, Ca, Cb, Cc and Cd, respectively, connected from source to drain of the respective MOSFET. A first leg or leading leg of the converter has MOSFET QA and QB connected in series with one another between positive and negative voltage rails of input voltage V_{I}. A second leg or lagging leg of the converter has MOSFETs QC and QD connected in series with one another between positive and negative voltage rails of input voltage V_{I}. The drains of MOSFETs QA and QC are connected to the positive rail and the sources of MOSFETs QB and QD are connected to the negative rail.

One end of a primary winding of a transformer T1 having a center tapped secondary, is connected between MOSFETs QA and QB. The other end of the primary winding of transformer T1 is connected between MOSFETs QC and QD. The dot convention in FIG. 1 and FIGS. 4-7 illustrates when the dotted end of the primary winding has a positive voltage then a positive voltage will be induced at the dotted end of the secondary winding. The secondary winding of transformer T1 is connected to the output stage 14 and has an anode of a first output rectifier D1 couple to a first end of the secondary winding and an anode of a second output rectifier D2 coupled to a second end of the secondary winding. The center tap of the secondary winding is coupled to ground. The cathodes of the first output rectifier D1 and the second output rectifier D2 are coupled to a common node (CN) that is coupled to an output inductor L and output capacitor Co, which are used to smooth output current Io and output voltage V0.

Power delivery by the input stage 12 to the output stage 14 is provided by alternately switching between turning on and off a first diagonal transistor pair QA and QD and a second diagonal transistor pair QC and QB via gate control signals QA_CTL, QB_CTL, QC_CTL and QD_CTL provided by controller 16 and coupled to gates of QA, QB, QC and QD, respectively. The phase-shifted full bridge DC/DC converter 10 employs zero voltage switching (ZVS) to reduce power dissipation by the converter. ZVS occurs when a power device begins conduction with a near zero-voltage across the device. Achieving zero-voltage switching over a large range of line voltages and loads is desirable to reduce electromagnetic interference. Previous approaches to achieve zero-voltage switching over large line voltage and load variations has increased the conduction losses of the power devices by increasing the currents carried by the switching devices after they were turned on, resulting in limited gain in efficiency.

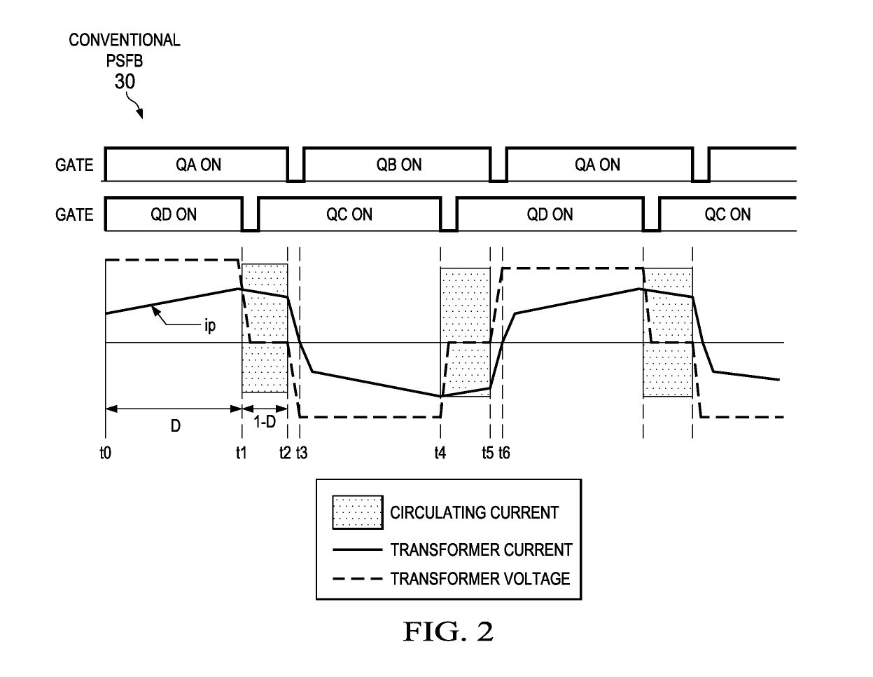

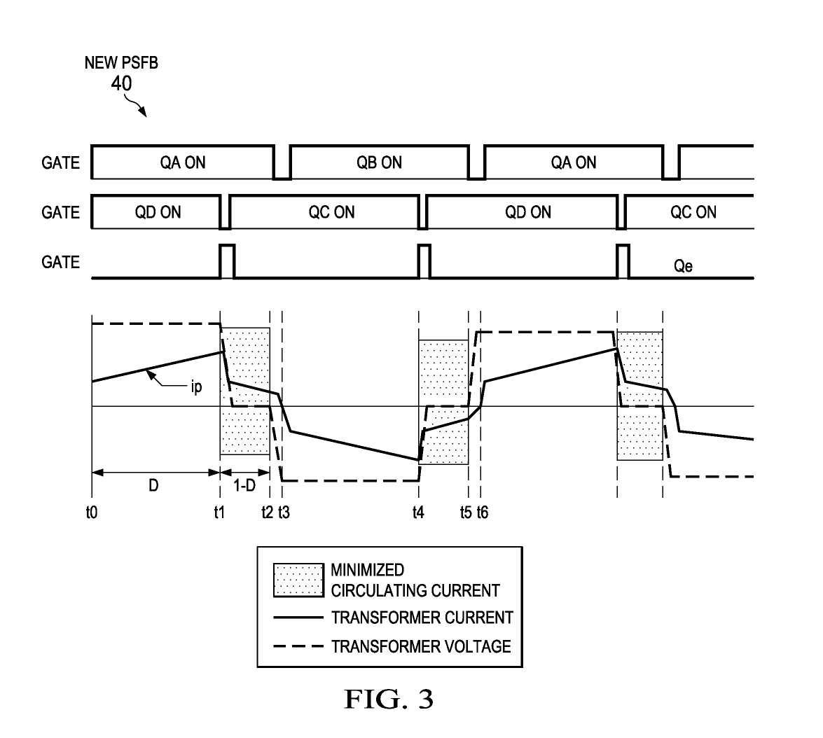

In the phase-shifted full bridge converter 10, shown in FIG. 1, MOSFET switches QA, QB, QC, and QD operate at a fixed frequency, and the on time of diagonally conducting power devices is not varied, but rather the power devices in each leg (one inverter leg having QA and QB, the other leg having QC and QD) are made to alternately conduct at a duty cycle approaching 50%, as can be seen in the waveform diagrams shown in FIGS. 2-3. The phase shift between the operation of the devices of each of the legs determines when diagonal switches are conducting at the same time and therefore delivering power to a load.

In the converter 10 of FIG. 1, the transformer primary current flowing at turn-off of one transistor charges the parasitic capacitances of that transistor while reducing the charge on the parasitic capacitances of the other transistor in the same leg, thereby reducing the voltage across the other transistor, which is also the next transistor to be turned on. As a condition of ZVS, the turn-on of the transistor in the same leg with the transistor that was just turned off, needs to be delayed until the voltage across the transistor has been reduced to near zero by the charging of its associated parasitic capacitance. During the switching between one diagonal pair and the other diagonal pair, a zero voltage across the transformer occurs and no power is delivered to the output stage. However, a circulating current runs through the primary resulting in lost power.

In accordance with an aspect of the present invention, a switchable circulating current control circuit 18 can provide a portion of the output current to reduce the output current provided from the secondary winding to reduce circulating current in the primary winding during a freewheeling time period. The circulating current occurs during the switching from one diagonal pair of switching transistors to the other diagonal pair of switching transistors.

As illustrated in FIG. 1, the circulating current control circuit 18 can include a capacitor Ce coupled to the common node (CN) and a switch in the form of a MOSFET Qe having a body diode De located between the capacitor Ce and ground. The capacitor Ce and the body diode of Qe form a snubber that can be charged to the transformer secondary winding peak voltage, which is also the peak of the voltage ringing. The switch Qe can be turned on just prior to the freewheeling time period in which the circulating current begins to circulate through the primary of the transformer T1. The turning on of the switch Qe causing the capacitor Ce to provide a voltage to the common node that causes the steady state voltage (e.g., 30 volts) on the secondary winding to rise to substantially the same voltage as the capacitor voltage (e.g., 40 volts). This causes the voltage on the primary winding to increase, thus reducing the circulating current through the primary winding. A portion of the output current previously provided by the secondary winding is now provided by the capacitor Ce.

The longer Qe is turned on, the greater the primary circulating current is reduced. The circulating current can be controlled by adjusting a pulse width of a circulating current control signal (QE_CTL) provided by the controller 16 and that is coupled to the gate of the switch Qe. In accordance with another aspect of the invention, a current sensor 20 is coupled to the output of the output stage 14 to measure the output current Io and provide a feedback signal Io_FB to the controller 16. The controller 16 can employ the feedback signal Io_FB to determine the pulse width of the circulating current control signal based on load and line conditions to reduce circulating current while maintaining a wide range of ZVS. The capacitor Ce also provides the advantages of discharging the circulation energy to the output and absorbing the leakage energy by clamping the transformer output ringing during switching between the circulating current time period during freewheeling mode and the power delivery mode. Furthermore, the capacitor Ce can be precharged by a bias (not shown) during full bridge startup to reduce ringing during startup.

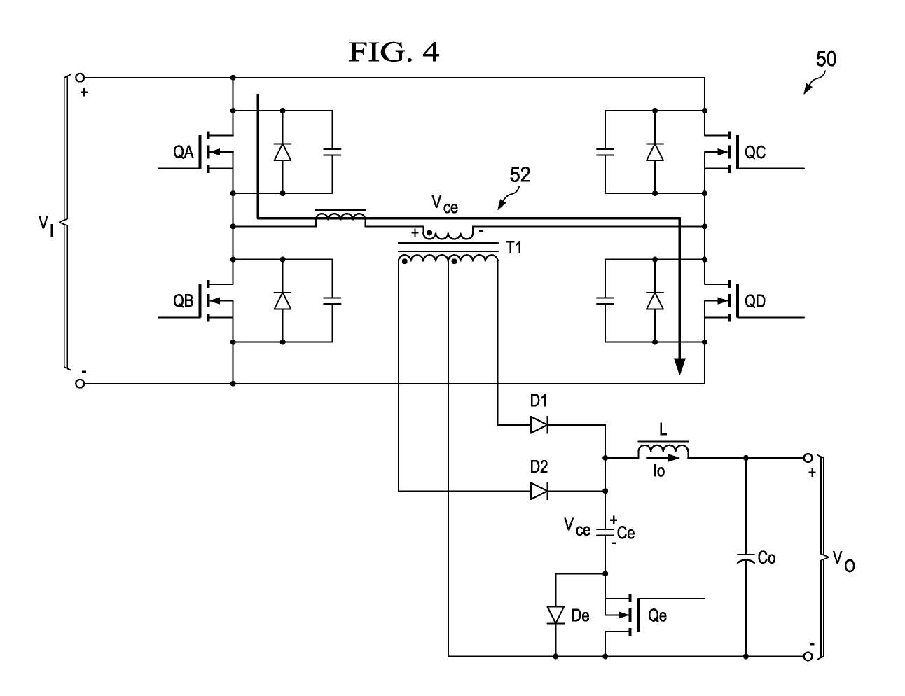

FIG. 2 illustrates waveform timing diagrams 30 of input switching signals and primary winding signals of a conventional phase-shifted full bridge DC/DC converter. FIG. 3 illustrates waveform timing diagrams 40 of input switching signals, primary winding signals and a blocking control signal of a phase-shifted full bridge DC/DC converter in accordance with an aspect of the present invention. The waveform timing diagrams will be explained with reference to current flow schematic diagrams shown in FIGS. 4-7 to further facilitate explanation of the timing and operation of the phase-shifted full bridge DC/DC converter 10 of FIG. 1.

At time t0, as illustrated in waveform timing diagrams 30 and 40, diagonal switches QA and QD are on. This causes current 52 to flow through switch QA, primary winding of transformer T1 and through switch QC delivering power to the output stage of the phase-shifted full bridge DC/DC converter, as illustrated in the current flow schematic diagram 50 of FIG. 4. As illustrated in the dot convention of FIG. 4, the positive voltage is provided to the left side of the primary winding, providing a positive voltage on the left side of the secondary winding and the second output rectifier D2. This results in biasing the second output rectifier D2 and providing output current to the output inductor L and output capacitor C from the secondary winding through the second output rectifier D2.

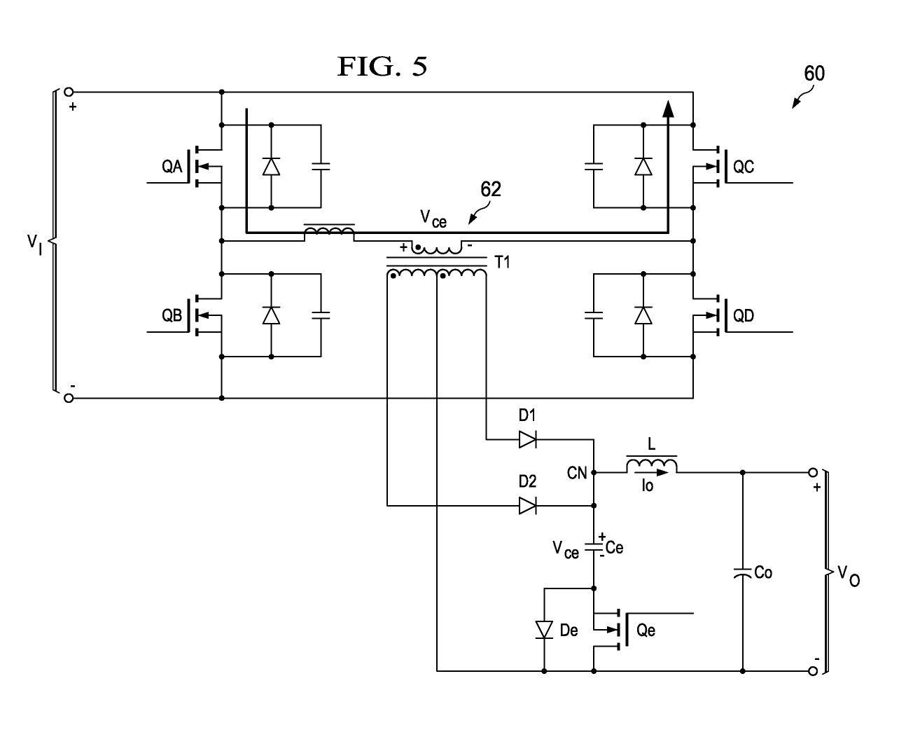

At time t1, as illustrated in waveform timing diagrams 30 and 40, diagonal switch QD is turned off to initiate a freewheeling time period. This causes circulating current to flow through switch QA, primary winding of transformer T1 and initially charging parasitic capacitance of switch QC to substantially to the same voltage as the upper voltage rail of VI, until it is clamped by the body diode of switch QC. Once this occurs, switch QC can be turned on under ZVS and circulating current 62 continues to flow through switch QA, the primary winding and the switch QC, as illustrated in current flow schematic diagram 60 of FIG. 5, until a time t2 in which QA is turned off. During the freewheeling time period from t1 to t2, the transformer voltage will eventually drop to zero delivering no power to the output stage of the phase-shifted full bridge DC/DC converter.

As illustrated in waveform timing diagrams 40, a circulating current control pulse is provided to Qe just prior to the beginning of the freewheeling time period from t1 to t2. The turning on of the switch Qe causing the capacitor Ce to connect to nodes of CN and output power return (Ground). The capacitor Ce's voltage is greater than an output voltage of the secondary winding, which causes the secondary current and hence the primary current to decrease. By controlling Qe's turn-on time, the primary current, namely circulating current in freewheeling time period, can be reduced to a desired level. The reduction in circulating current can be seen at the initial time of the freewheeling time period from t1 to t2 in waveform timing diagrams 40 compared to waveform timing diagrams 30 of the conventional phase-shifted full bridge DC/DC converter.

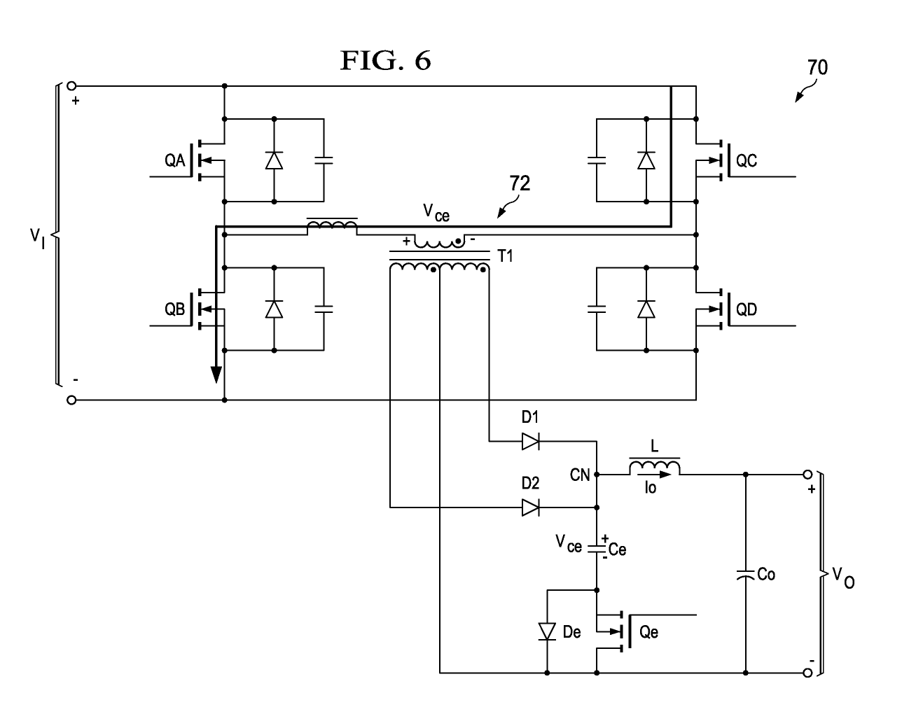

The transformer current continues to fall after time t2, until a time t3, in which switch B is turned on, such that diagonal switches QC and QB are on. This causes current 72 to reverse flow and flow through switch QC, primary winding of transformer T1 and through switch QB delivering power to the output stage of the phase-shifted full bridge DC/DC converter, as illustrated in the current flow schematic diagram 70 of FIG. 6. As illustrated in the dot convention of FIG. 6, the positive voltage is provided to the right side of the primary winding, providing a positive voltage on the right side of the secondary winding and the first output rectifier D2. This results in biasing the first output rectifier D1 and providing output current to the output inductor L and output capacitor C from the secondary winding through the first output rectifier D1. This reversal in current can result in transformer ringing due to leakage energy, which is absorbed by clamping the transformer output ringing via the capacitor Ce. If the transformer primary current is large enough to fully discharge QB to zero volts before QB is turned on at t3, QB achieves ZVS.

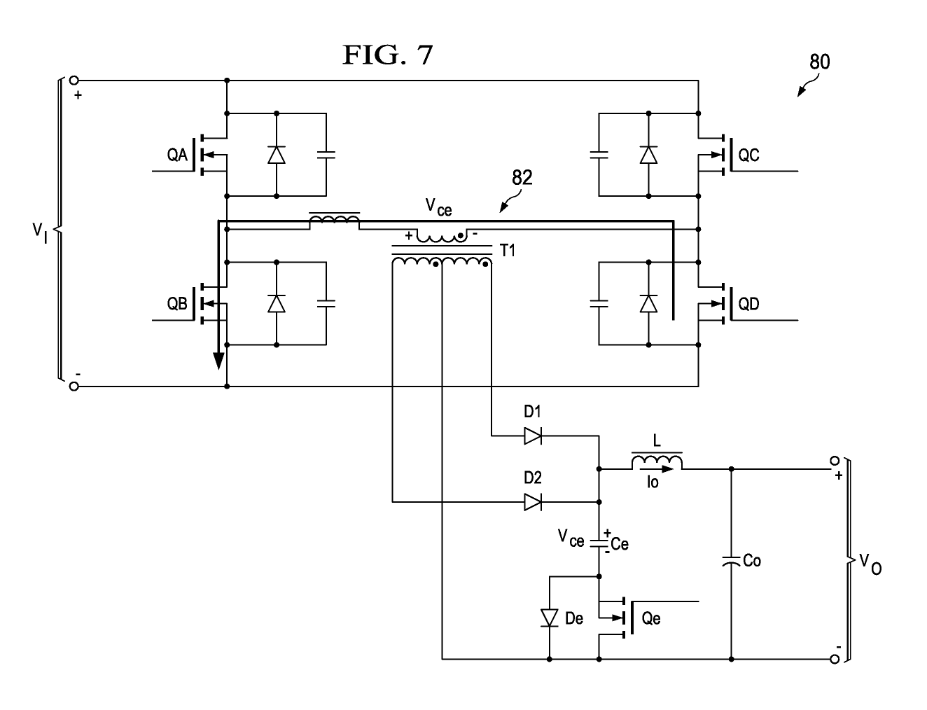

At time t4, as illustrated in waveform timing diagrams 30 and 40, diagonal switch QC is turned off to initiate a freewheeling time period. This causes circulating current to flow through body diode of switch QD, primary winding of transformer T1 and initially discharge parasitic capacitance of switch QD to substantially to the same voltage as the lower voltage rail of V_{I}, until it is clamped by the body diode of switch QD. Once this occurs, switch QD can be turned on under ZVS and circulating current 82 continues to flow through switch QD, the primary winding and the switch QB, as illustrated in current flow schematic diagram 80 of FIG. 7, until a time t5, in which QB is turned off. During the freewheeling time period from t4 to t5, the transformer voltage will eventually drop to zero delivering no power to the output stage of the phase-shifted full bridge DC/DC converter.

As illustrated in waveform timing diagrams 40, a circulating current control pulse is provided to Qe just prior to the beginning of the freewheeling time period from t4 to t5. The turning on of the switch Qe causes the capacitor Ce to connect to nodes of CN and output power return (Ground). The capacitor Ce's voltage is greater than an output voltage of the secondary winding, which causes the secondary current and hence the primary current to decrease. By controlling Qe's turn-on time, the primary current, namely circulating current in freewheel period, can be reduced to a desired level. The reduction in circulating current can be seen at the initial time of the freewheeling time period from t4 to t5 in waveform timing diagrams 40 compared to waveform timing diagrams 30 of the conventional phase-shifted full bridge DC/DC converter.

After the switch QB is turned off, the parasitic capacitance of the switch QB charges up to substantially to the same voltage as the upper voltage rail of V_{I}, until it is clamped by the body diode of switch QA. The transformer current continues to fall after time t5, until a time t6, in which switch QA is turned on at ZVS, such that diagonal switches QA and QD are on ending the freewheeling time period. This causes current 52 to reverse flow and flow through switch QA, primary winding of transformer T1 and through switch QD delivering power to the output stage of the phase-shifted full bridge DC/DC converter, as illustrated in the current flow schematic diagram 50 of FIG. 4. This reversal in current can result in transformer ringing due to leakage energy, which is absorbed by clamping the transformer output ringing via the capacitor Ce and Qe's body diode. The process described above with respect to FIGS. 2-7 continuously repeats during operation of the phase-shifted full bridge DC/DC converter.

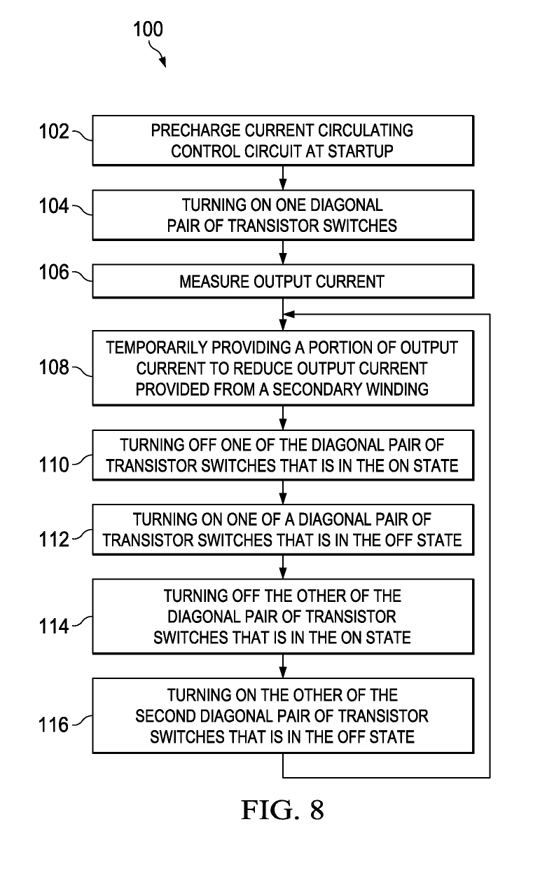

In view of the foregoing structural and functional features described above, certain methods will be better appreciated with reference to FIG. 8. It is to be understood and appreciated that the illustrated actions, in other embodiments, may occur in different orders and/or concurrently with other actions. Moreover, not all illustrated features may be required to implement a method.

FIG. 8 illustrates an example of a method 100 for reducing circulating current in a phase-shifted full bridge DC/DC converter in accordance with an aspect of the present invention. The methodology begins at 102 where a circulating current control circuit is precharged by a separate bias circuit (not in the drawings) at startup to reduce startup current. The circulating current control circuit is configured to provide a portion of output current to reduce output current provided from the secondary winding during an initial time of a freewheeling time period and reduce the circulating current in the primary winding. The circulating current control circuit can be, for example, a capacitor series coupled with a switch coupled to a pair of output rectifiers of an output stage of the converter. The methodology then proceeds to 104 where one of a diagonal pair of transistor switches is turned on to delivery power during a power delivering time period. At 106, the output current is measured, for example, employing a current sensor. The methodology then proceeds to 108.

At 108, a circulating current control signal is applied to the circulating current control circuit to provide a portion of output current to reduce output current from the secondary winding. The pulse width of the circulating current control signal can be based on the amount of measured output current. For example, the pulse width can control an amount of time that a capacitor can provide output current to an output inductor. At 110, one of the diagonal pair of transistors switched that is in the on state (e.g., set for power delivery mode) is turned off. At 112, one of the diagonal pair of transistor switches in the off state (e.g., set for being off during power delivery mode) is turned on. At 114, the other of the diagonal pair of transistors switched that is in the on state is turned off. At 116, the other of the diagonal pair of transistor switches in the off state is turned on. The methodology then returns to repeats block 106-116, until the converter is shut down.

What have been described above are examples of the invention. It is, of course, not possible to describe every conceivable combination of components or method for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A phase-shifted full bridge converter comprising:
a transformer having a primary winding and a secondary winding having a center tap;
an input stage comprising a full bridge switching circuit coupled to the primary winding; and
an output stage coupled to the secondary winding, the output stage comprising a circulating current control circuit to provide a portion of output current to reduce output current provided from the secondary winding during a freewheeling time period and reduce the circulating current in the primary winding.

2. The converter of claim 1, wherein the output stage further comprises a first output rectifier having an anode coupled to a first end of the secondary winding and a cathode coupled to a common node, and a second output rectifier having an anode coupled to a second end of the secondary winding and a cathode coupled to the common node and an output inductor coupled to the common node and an output capacitor that is coupled between an output terminal and the center tap, wherein the circulating current control circuit is coupled to the common node.

3. The converter of claim 2, wherein the circulating control circuit comprises a capacitor coupled between the common node and a switch coupled to ground.

4. The converter of claim 3, further comprising a controller that provides a circulating current control signal having a pulse width that controls the amount of time the capacitor provides a portion of the output current.

5. The converter of claim 4, wherein the controller dynamically adjusts the pulse width of the circulating current control signal based on the output current of the output stage.

6. The converter of claim 5, further comprising a current sensor that senses the output current of the output stage and provides a feedback signal to the controller.

7. The converter of claim 1, wherein the full bridge switching circuit comprises a first pair of series coupled switching transistor pairs coupled between positive and negative rails of an input voltage with a first end of the primary winding being coupled between the first pair of series coupled transistors, and a second pair of series coupled switching transistor pairs coupled between positive and negative rails of an input voltage with a second end of the primary winding being coupled between the first pair of series coupled transistors.

8. The converter of claim 7, further comprising a controller that controls the switching of the first and second transistor pairs via gate control signals, wherein the controller alternately switches between a first diagonal transistor pair and a second diagonal transistor pair of the first and second transistor pairs to deliver power to the output stage during power delivery time periods.

9. The converter of claim 8, wherein the controller adjusts the phase of the gate control signals to provide zero voltage switching (ZVS) during switching between the first diagonal pair and the second diagonal pair causing freewheeling time periods that result in circulating current flowing through the primary winding.

10. The converter of claim 9, wherein the circulating current control circuit comprises a series coupled capacitor and switch, the capacitor discharging the circulation energy to an output of the output stage during a portion of a freewheeling time period and absorbing the leakage energy by clamping the transformer output ringing during switching from the freewheeling time period to the power delivery time period.

11. A DC/DC converter comprising:
a transformer having a primary winding and a secondary winding having a center tap;
an input stage comprising a full bridge switching circuit having first and second transistor pairs coupled to one another through the primary winding;
a controller that controls the switching of the first and second transistor pairs via gate control signals, wherein the controller alternately switches between a first diagonal transistor pair and a second diagonal transistor pair of the first and second transistor pairs to deliver power to the output stage during power delivery time periods; and
an output stage coupled to the secondary winding, the output stage comprising:
a first output rectifier having an anode coupled to a first end of the secondary winding and a cathode coupled to a common node;
a second output rectifier having an anode coupled to a second end of the secondary winding and a cathode coupled to the common node;
an output inductor having a first end coupled to the common node and a second end that is coupled to an output capacitor, which is also coupled between an output terminal and the center tap; and
a circulating current control circuit coupled to the common node to provide a portion of output current to the output inductor to reduce output current provided by the secondary winding during an initial time of a freewheeling time period and reduce the circulating current in the primary winding.

12. The converter of claim 11, wherein the circulating current control circuit comprises a capacitor coupled between the common node and a switch coupled to ground.

13. The converter of claim 12, wherein the controller provides a circulating current control signal having a pulse width that controls the amount of time the capacitor voltage is applied to the common node.

14. The converter of claim 13, wherein the controller dynamically adjusts the pulse width of the blocking control signal based on an output current of the output stage.

15. The converter of claim 14, further comprising a current sensor that senses the output current of the output inductor and provides a feedback signal to the controller.

16. A method for reducing circulating current in phase-shifted full bridge converter having an input stage coupled to an output stage by a transformer, the method comprising:
turning on a first diagonal pair of transistor switches of the input stage;
temporarily providing a portion of output current to reduce output current provided by a secondary winding of the transformer resulting in the reduction of circulating current in a primary winding of the transformer;
turning off one the first diagonal pair of transistor switches;
turning on one of a second diagonal pair of transistor switches;
turning off the other of the first diagonal pair of transistor switches; and
turning on the other of the second diagonal pair of transistor switches.

17. The method of claim 16, further comprising precharging a circulating current control circuit at startup that also provides the temporarily providing a portion of output current.

18. The method of claim 16, wherein the circulating current control circuit comprises a capacitor coupled to an output of a rectifier of the output stage and a transistor switch coupled to ground, and the circulating current control signal is a pulse to the gate of the transistor switch.

19. The method of claim 18, wherein the pulse begins just prior to the turning off of the one the first diagonal pair of transistor switches, and ends just after the turning on of the one of a second diagonal pair of transistor switches.

20. The method of claim 19, wherein the pulse width is adjusted based on an output current of the output stage.
